(19) United States
(12) Patent Application Publication
(10) Pub. No.: US 2009/0049146 A1
(43) Pub. Date: Feb. 19, 2009

(54) SYSTEM AND METHOD FOR DATA TRANSMISSION

(76) Inventors: Makoto Okita, Tokyo (JP); Takayuki Shigematsu, Tokyo (JP)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/092,359

(22) PCT Filed: Nov. 4, 2005
(86) PCT No.: PCT/JP2005/020261

§ 371 Date: May 1, 2008

(51) Int. Cl. G06F 15/16

(52) U.S. Cl. 709/206

(57) ABSTRACT

An improved system and method for data transmission is provided without changing the configuration of a client. A data-reading server (2) receives an e-mail including a URL from an e-mail client (6), extracts the URL from the e-mail, and accesses a Web server (4) via an internal network (160) to receive. Web data. The data-reading server (2) composes an e-mail by converting the received data into data in an MIME format and transmits the e-mail to the e-mail client (6). The user of the e-mail client (6) can read the Web page in an intranet from outside the intranet through an e-mail browser.

### PRIORITY CLAIM

The present invention claims priority under 35 U.S.C. 119 to Japanese PCT Application Serial No. PCT/JP2005/020261, filed on Nov. 4, 2005, the disclosure of which is hereby incorporated by reference in its entirety.

### TECHNICAL FIELD

The present invention relates to a system and method for data transmission which are used for transmitting data, reading a Web page, and the like.

### BACKGROUND

For example, Patent Document 1 discloses a method in which a client computer uses an e-mail to acquire a content of a Web page from a server computer. However, adoption of the method disclosed in Patent Document 1 requires a change in configuration within a client-side network.

Therefore, it is desired to provide a system for data transmission which is improved so as to obtain a Web content by use of an e-mail without a change in the configuration of a client.

Patent Document 1: JP 2004-173116 A

### SUMMARY

### Problem to be Solved by the Invention

The present invention has been made against the above-mentioned backdrop, and an object thereof is to provide a system and method for data transmission which is suitable for acquiring a Web content by use of an e-mail.

### Means for Solving the Problem

In order to achieve the above-mentioned object, according to the present invention, there is provided a data transmission system, including: a first network; and a second network, the first network having predetermined data transmitted inside the first network, the first network and the second network at least having data transmitted therebetween by e-mail, an e-mail that contains specification data for specifying the predetermined data being transmitted from the second network to the first network. The first network includes: a data storage device for storing the predetermined data; and a data-reading device for reading, from among the stored predetermined data, predetermined data indicated by the specification data contained in the e-mail received from the second network, and returning an e-mail containing the read predetermined data to the second network.

Further, according to the present invention, there is provided a data transmission method for a data transmission system including a first network and a second network, the first network having predetermined data transmitted inside the first network, the first network and the second network at least having data transmitted therebetween by e-mail, an e-mail that contains specification data for specifying the predetermined data being transmitted from the second network to the first network. The data transmission method includes: a storage step of storing, in the first network, the predetermined data; and a data-reading step of reading, in the first network, from among the stored predetermined data, predetermined data indicated by the specification data contained in the e-mail received from the second network, and returning an e-mail containing the read predetermined data to the second network.

Further, according to the present invention, there is provided a data transmission program for a data transmission system including a first network that includes respective computers and a second network, the first network having predetermined data transmitted inside the first network, the first network and the second network at least having data transmitted therebetween by e-mail, an e-mail that contains specification data for specifying the predetermined data being transmitted from the second network to the first network. The data transmission program causes the computers of the first network to execute: a storage step of storing the predetermined data; and a data-reading step of reading, from among the stored predetermined data, predetermined data indicated by the specification data contained in the e-mail received from the second network, and returning an e-mail containing the read predetermined data to the second network.

### EFFECTS OF THE INVENTION

According to the system and method for data transmission according to the present invention, it is possible to obtain Web content by use of an e-mail without a change in configuration of a client.

### BRIEF DESCRIPTION OF THE DRAWINGS

FIG. 1 is a diagram exemplifying a configuration of a Web page-reading system to which a method of reading a Web page according to the present invention is applied.

FIG. 2 is a diagram exemplifying hardware configurations of a data-reading server, a Web server, an e-mail client, and a search server that are shown in FIG. 1.

FIG. 3 is a diagram showing a mode of Web page reading performed between the e-mail client and the data-reading server in the Web page-reading system shown in FIG. 1.

FIG. 4 is a diagram showing a mode of Web page reading by use of form inputting which is performed among the e-mail client, the data-reading server, and the search server in the Web page-reading system.

FIG. 5 is a diagram showing a data-reading server program running on the data-reading server shown in FIG. 1.

FIG. 6 is a diagram showing information contained in an e-mail transmitted from the e-mail client shown in FIG. 1 to the data-reading server.

FIG. 7 is a diagram showing a configuration of a portal processing section shown in FIG. 5.

FIG. 8 is a diagram showing a configuration of an HTML tag conversion section shown in FIG. 5.

FIG. 9 is a diagram showing an example of a structure of MIME-format data according to the present invention.

FIG. 10 is a diagram showing information contained in the e-mail transmitted from the data-reading server shown in FIG. 1 to the e-mail client.

FIG. 11 is a diagram showing a configuration of a user management section shown in FIG. 5.

FIG. 12 is a diagram showing a Web server program running on the Web server shown in FIG. 1.

FIG. 13 is a diagram showing an e-mail client program running on the e-mail client shown in FIG. 1.

FIG. 14 is a diagram showing information contained in an HTTP request transmitted from the e-mail client shown in FIG. 1 to the search server.

FIG. 15 is a diagram showing information contained in an HTTP response transmitted from the search server shown in FIG. 1 to the e-mail client.

FIG. 16 is a diagram showing a search server program running on the search server shown in FIG. 1.

FIG. 17 is a communication sequence diagram showing an overall operation of the Web page-reading system shown in FIG. 1 in a case where the form inputting is not taken into consideration.

FIG. 18 is a communication sequence diagram showing an overall operation of the Web page-reading system shown in FIG. 1 in a case where the form inputting is taken into consideration.

### DETAILED DESCRIPTION

### Best Mode for Carrying Out the Invention

Hereinafter, description will be made of an embodiment of the present invention.

Web page-reading system 1

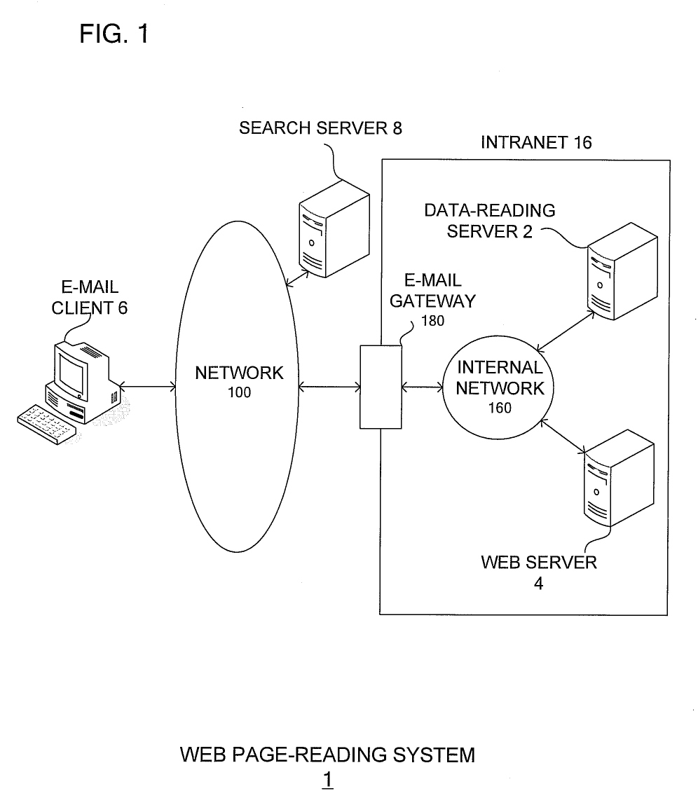

FIG. 1 is a diagram exemplifying a configuration of a Web page-reading system 1 to which a method of reading a Web page according to the present invention is applied. As shown in FIG. 1, the Web page-reading system 1 is configured by including an intranet 16, an e-mail client 6, and a search server 8 which are connected to one another via a network 100.

The intranet 16 is configured by including a data-reading server 2, a Web server 4, and an e-mail gateway 180 which are connected to one another via an internal network 160. The e-mail gateway 180 has a function of exchanging an e-mail between the internal network 160 within the intranet 16 and the network 100.

Note that in the following description, a device such as the data-reading server 2 which can serve as a subject of information processing and communications in the Web page-reading system 1 will be referred to generically as “node”.

Hardware

Hereinafter, description will be made of a hardware configuration of each of the components of the Web page-reading system 1.

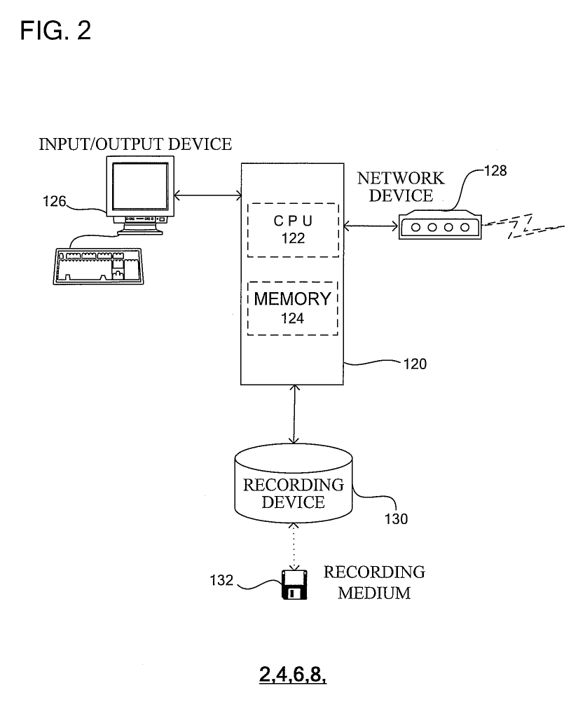

FIG. 2 is a diagram exemplifying the hardware configuration of each of the data-reading server 2, the Web server 4, the e-mail client 6, and the search server 8 that are shown in FIG. 1. As shown in FIG. 2, the data-reading server 2, the Web server 4, the e-mail client 6, and the search server 8 are each configured by including: a main body 120 that includes a CPU 122 and a memory 124; an input/output device 126 that includes a keyboard and a display device; a network device 128 for performing communications with another node; and a recording device 130, such as a CD drive and an HD drive, for performing recording and reproduction of data on a recording medium 132.

In short, each of the data-reading server 2, the Web server 4, the e-mail client 6, and the search server 8 has the hardware components of a computer capable of information processing and communications with another node.

Mode of Web page reading

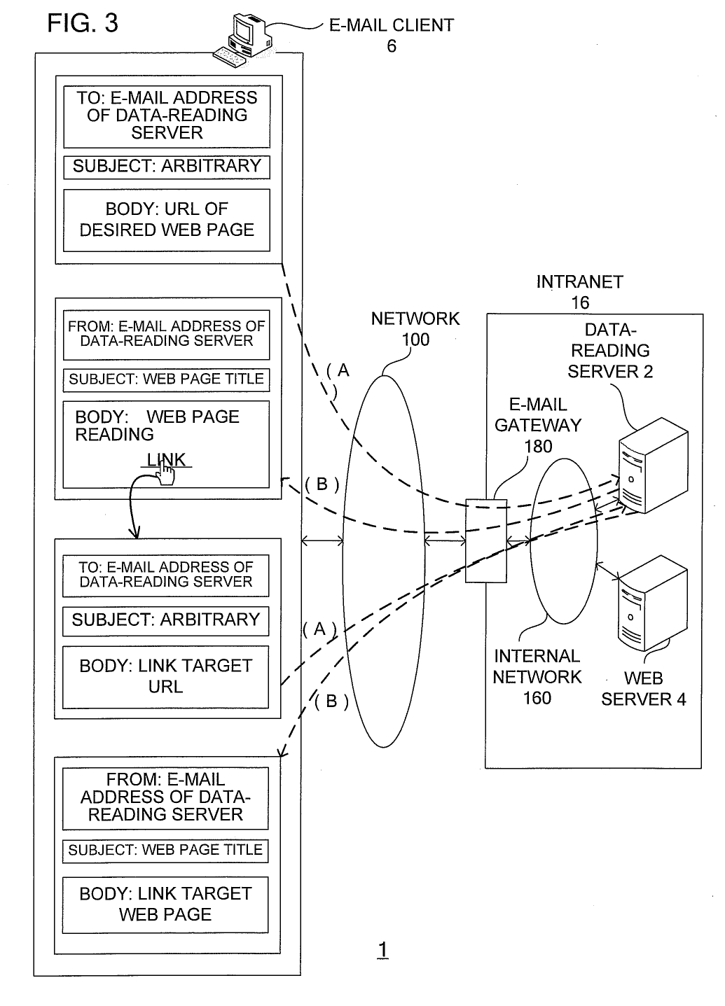

FIG. 3 is a diagram showing a mode of Web page reading performed between the e-mail client 6 and the data-reading server 2 in the Web page-reading system 1 shown in FIG. 1. In the Web page-reading system 1, in response to an e-mail that contains a uniform resource locator (URL) and is received from the e-mail client 6 as shown in FIG. 3 by the dotted lines (A), the data-reading server 2 returns an e-mail containing data described in HyperText Markup Language (HTML) as shown in FIG. 3 by the dotted lines (B) in order to provide a content of a Web page indicated by the above-mentioned URL.

Further, the e-mail received from the data-reading server 2 is displayed by an e-mail client program capable of displaying Web data. In other words, in the Web page-reading system 1, a user of the e-mail client 6 can read a Web page existing inside an intranet from outside the intranet by using an e-mail through the e-mail client 6. Further, the user of the e-mail client 6 can read a Web page at a link target by using an e-mail containing a URL of the link target that is composed automatically by clicking on a link object within a Web page inside the intranet which is displayed on the e-mail client 6.

Mode of Web page reading by use of form inputting

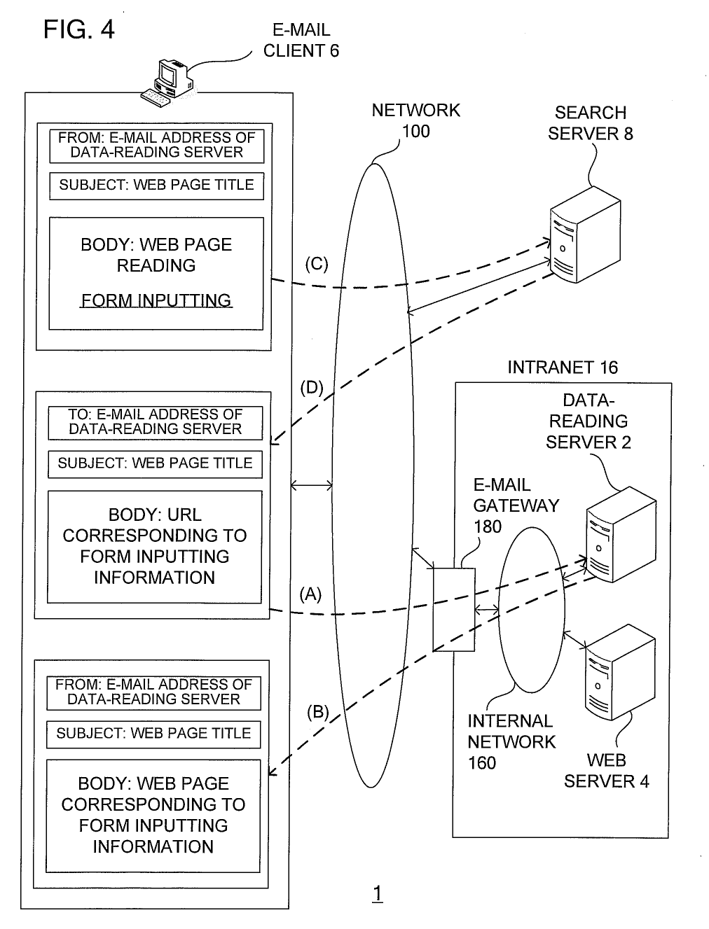

FIG. 4 is a diagram showing a mode of Web page reading by use of form inputting which is performed among the e-mail client 6, the data-reading server 2, and the search server 8 in the Web page-reading system 1. The “form inputting” means that the user of the e-mail client 6 uses a form tag embedded in a Web page to input text and select from menu items.

When the user of the e-mail client 6 performs the form inputting and clicks on a transmission button embedded in the Web page, a HyperText Transfer Protocol (HTTP) request is transmitted to the search server 8 as shown by the dotted line (C). In response to the HTTP request, the search server 8 returns a mailto-format HTTP response containing a URL corresponding to the form inputting information to the e-mail client 6 as shown by the dotted line (D).

The mailto-format HTTP response has a response code of a “302 Found” status (status indicating that the requested resource is provided by a “Location” field within a response header), and the “Location” field shows a “mailto” tag (HTML link tag for automatically starting an e-mail) with the URL corresponding to the form inputting information set as a body. Accordingly, upon reception of the mailto-format HTTP response, the e-mail client 6 automatically composes an e-mail containing the URL corresponding to the form inputting information.

The user of the e-mail client 6 can read a Web page corresponding to the form inputting information by using the e-mail composing automatically and containing the URL corresponding to the form inputting information.

Software

Next, description will be made of software on each node of the Web page-reading system 1. Each of the following programs shown in respective figures is, for example, supplied to each node via the recording medium 132 (FIG. 2), loaded into the memory 124, and executed on an OS (not shown) running on each node while concretely using the hardware.

Data-reading server program 20

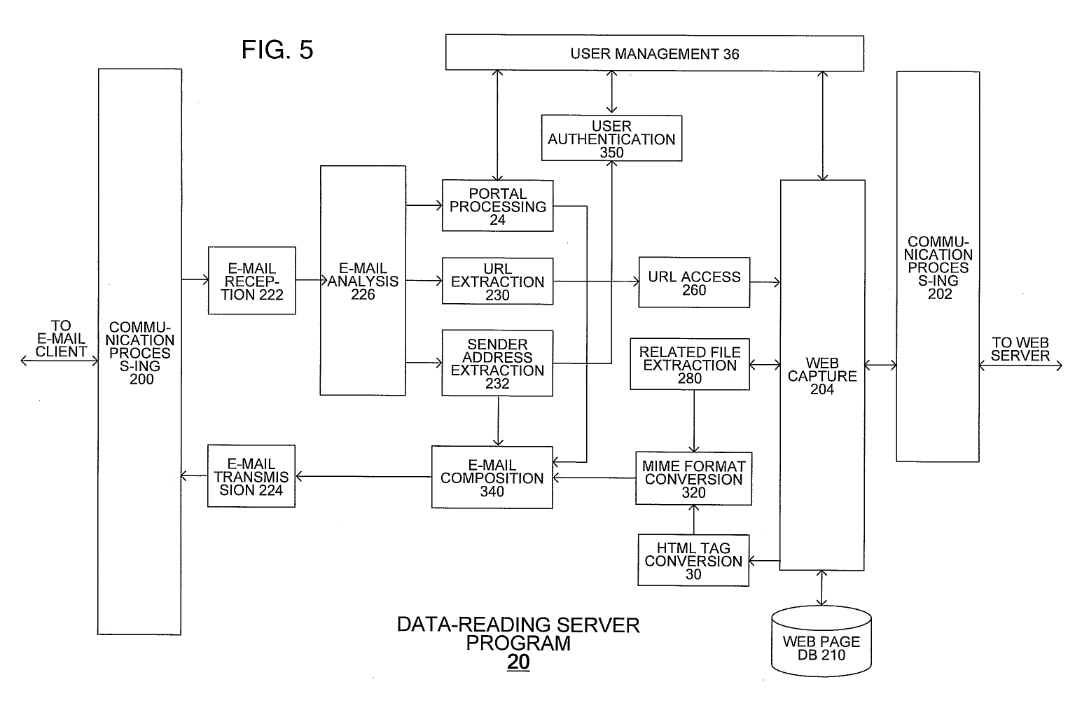

FIG. 5 is a diagram showing a data-reading server program 20 running on the data-reading server 2 shown in FIG. 1. As shown in FIG. 5, the data-reading server program 20 is configured by including communication processing sections 200 and 202, a Web capture section 204, a Web page database (Web page DB) 210, an e-mail reception section 222, an e-mail transmission section 224, an e-mail analysis section 226, a URL extraction section 230, a sender address extraction section 232, a portal processing section 24, a URL access section 260, a related file extraction section 280, an HTML tag conversion section 30, a multipurpose internet mail extension (MIME) format conversion section 320, an e-mail composition section 340, a user authentication section 350, and a user management section 36.

By those components, the data-reading server program 20 receives an e-mail containing a URL from the e-mail client 6 outside the intranet 16, extracts the URL from the received e-mail, accesses the Web server 4 inside the intranet 16, and receives data (Web data) constituting a Web page. In addition, the data-reading server program 20 composes an e-mail by converting the received Web data into a MIME format, and transmits the e-mail to the e-mail client 6.

In the data-reading server program 20, the communication processing section 200 performs a processing for performing communications with another node via the network 100. In other words, the communication processing section 200 receives an e-mail from the e-mail client 6 via the network 100, the e-mail gateway 180, and the internal network 160, and outputs the e-mail to the e-mail reception section 222. In addition, the communication processing section 200 transmits an e-mail inputted from the e-mail transmission section 224 to the e-mail client 6 via the internal network 160, the e-mail gateway 180, and the network 100.

The communication processing section 202 performs a processing for performing communications with another node via the internal network 160. In other words, the communication processing section 202 transmits a signal inputted from the Web capture section 204 to the Web server 4 via the internal network 160. In addition, the communication processing section 202 receives Web data from the Web server 4 via the internal network 160, and outputs the Web data to the Web capture section 204.

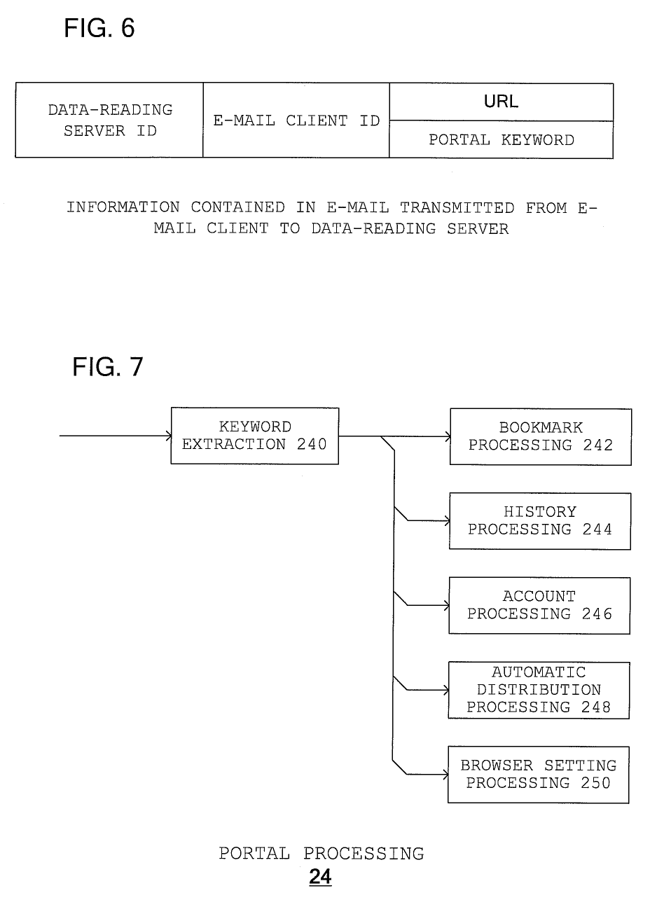

FIG. 6 is a diagram showing information contained in an e-mail transmitted from the e-mail client 6 shown in FIG. 1 to the data-reading server 2. As shown in FIG. 6, the e-mail transmitted from the e-mail client 6 to the data-reading server 2 contains a data-reading server ID, an e-mail client ID, and a URL of a Web page or a keyword for a portal function, which will be described later with reference to FIG. 7.

The e-mail reception section 222 (FIG. 5) receives the information of the e-mail shown in FIG. 6 from the communication processing section 200. Further, the e-mail reception section 222 outputs the received information of the e-mail to the e-mail analysis section 226, and starts a processing of the e-mail analysis section 226. The e-mail analysis section 226 receives the information of the e-mail shown in FIG. 6 from the e-mail reception section 222, and extracts sender address information and information of an e-mail body. The e-mail analysis section 226 outputs the extracted sender address information to the sender address extraction section 232.

Meanwhile, with regard to the information of the e-mail body, the e-mail analysis section 226 extracts only character string information on the first line, and ignores character string information on the second line and the subsequent lines. The e-mail analysis section 226 outputs the extracted character string information to the URL extraction section 230 in a case where the character string indicates a URL and otherwise to the portal processing section 24. The URL extraction section 230 outputs the URL inputted from the e-mail analysis section 226 to the URL access section 260.

The sender address extraction section 232 outputs the sender address information inputted from the e-mail analysis section 226 to the e-mail composition section 340. In addition, the sender address extraction section 232 outputs the sender address information to the user authentication section 350 for use in authentication of a sender of the e-mail.

FIG. 7 is a diagram showing a configuration of the portal processing section 24 shown in FIG. 5. As shown in FIG. 7, the portal processing section 24 is configured by including a keyword extraction section 240, a bookmark processing section 242, a history processing section 244, an account processing section 246, an automatic distribution processing section 248, and a browser setting processing section 250.

Based on the information of the e-mail body received from the e-mail client 6, the portal processing section 24 performs a processing (portal processing) for providing a Web browser with a portal function. Herein, the “portal function” represents a function of performing bookmark setting, registration of a history and display of a list thereof, account setting, setting of automatic distribution of a Web page, and browser setting, which is provided to a general Web browser.

The browser setting represents setting of a function necessary for the user of the e-mail client 6 to use a Web content, examples of which include deletion of a cookie and a history, setting of security items represented by setting of a secure socket layer (SSL) and a server certificate, and setting of a character code used in display on the e-mail client 6. Further, hereinafter, the information of the e-mail body useful for the portal processing section 24 to execute the processing will be referred to as a “portal keyword”.

To use the portal function, the user of the e-mail client 6 inputs a portal keyword in the e-mail body, and transmits the portal keyword to the data-reading server 2. Based on the portal keyword, the data-reading server 2 transmits Web data necessary for the user of the e-mail client 6 to use the portal function to the e-mail client 6. The user of the e-mail client 6 can perform registration and editing of the portal function by editing the transmitted Web data and responding to the data-reading server 2.

The keyword extraction section 240 extracts a portal keyword from the e-mail body, and based on the portal keyword, controls the portal processing performed by the bookmark processing section 242, the history processing section 244, the account processing section 246, the automatic distribution processing section 248, and the browser setting processing section 250.

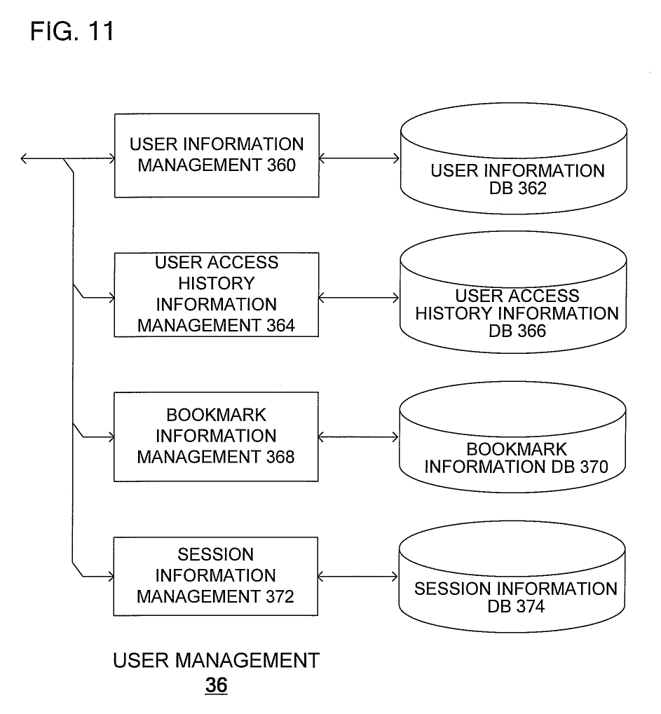

To perform the bookmark setting, the user of the e-mail client 6 inputs “bookmark” as the portal keyword in the e-mail body. If information of “bookmark” is inputted from the keyword extraction section 240 as the portal keyword, the bookmark processing section 242 accesses a bookmark information management section 368, which will be described later with reference to FIG. 11, to perform a processing for transmitting a Web page containing a list of bookmarks to the e-mail client 6.

The user of the e-mail client 6 can perform bookmark setting by performing form inputting by using a form tag embedded in the transmitted Web page containing the list of bookmarks and responding to the data-reading server 2. In addition, if information of “bookmark:(specific URL)” is inputted from the keyword extraction section 240 as the portal keyword, the bookmark processing section 242 performs a processing for adding the URL following “bookmark:” as a bookmark.

To read a list of the registered history, the user of the e-mail client 6 inputs “history” as the portal keyword in the e-mail body. If information of “history” is inputted from the keyword extraction section 240 as the portal keyword, the history processing section 244 performs a processing for transmitting a list of access history of a Web page to the e-mail client 6.

To set an account, the user of the e-mail client 6 inputs “account” as the portal keyword in the e-mail body. If information of “account” is inputted from the keyword extraction section 240 as the portal keyword, the account processing section 246 performs a processing for transmitting a page for setting an ID and a password to the e-mail client 6. The user of the e-mail client 6 can perform the setting by performing form inputting by using a form tag embedded in the transmitted Web page containing a setting form and responding to the data-reading server 2.

To perform setting of automatic distribution of a Web page, the user of the e-mail client 6 inputs “subscription” as the portal keyword in the e-mail body. If information of “subscription” is inputted from the keyword extraction section 240 as the portal keyword, the automatic distribution processing section 248 performs a processing for transmitting a page for setting the automatic distribution to the e-mail client 6. The user of the e-mail client 6 can perform the setting for allowing a Web page whose automatic distribution is desired by the user to be automatically distributed to the e-mail client 6 by performing form inputting by using a form tag embedded in the transmitted Web page containing a setting form and responding to the data-reading server 2. By this processing, if there is an update in the set Web page, the updated Web page is automatically distributed to the e-mail client 6.

To perform browser setting, the user of the e-mail client 6 inputs “option” as the portal keyword in the e-mail body. If information of “option” is inputted from the keyword extraction section 240 as the portal keyword, the browser setting processing section 250 performs a processing for transmitting a page for browser setting to the e-mail client 6. The user of the e-mail client 6 can perform the browser setting by performing form inputting by using a form tag embedded in the transmitted Web page containing a setting form and responding to the data-reading server 2.

The URL access section 260 (FIG. 5) receives a URL from the URL extraction section 230, and outputs to the Web capture section 204 a signal for requesting the Web server 4 to acquire Web data located in a resource indicated by the URL. The Web capture section 204 outputs the signal inputted from the URL access section 260 to the communication processing section 202. In addition, the Web capture section 204 acquires text data (HTML data) which is distributed from the Web server 4 in response to the request and described in an HTML format, and stores the acquired data in the Web page DB 210.

The related file extraction section 280 extracts identification information of a related file constituting the Web page from the HTML data acquired by the Web capture section 204. Based on the extracted identification information of the related file, the related file extraction section 280 outputs to the Web capture section 204 a signal for requesting the Web server 4 to distribute the related file.

The Web capture section 204 outputs the signal inputted from the related file extraction section 280 to the communication processing section 202. The Web capture section 204 acquires the related file distributed from the Web server 4 in response to the request for related file distribution, outputs the acquired file to the related file extraction section 280, and stores the acquired file data in the Web page DB 210. The related file extraction section 280 outputs the related file inputted from the Web capture section 204 to the MIME format conversion section 320.

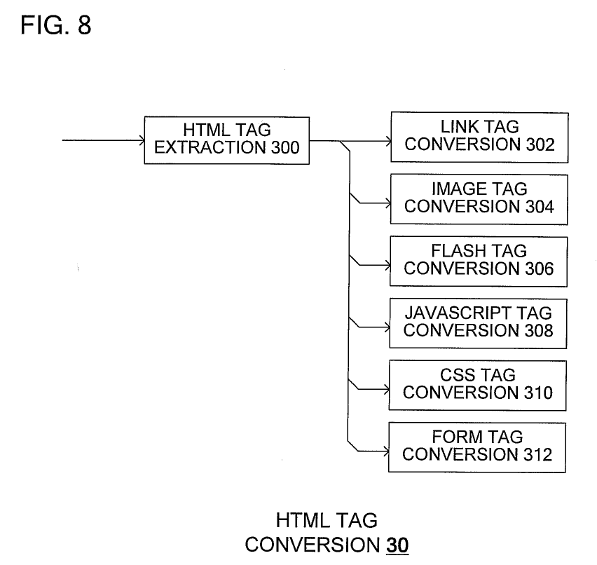

FIG. 8 is a diagram showing a configuration of the HTML tag conversion section 30 shown in FIG. 5. As shown in FIG. 8, the HTML tag conversion section 30 is configured by including an HTML tag extraction section 300, a link tag conversion section 302, an image tag conversion section 304, a Flash tag conversion section 306, a JavaScript tag conversion section 308, a Cascading Style Sheets (CSS) tag conversion section 310, and a form tag conversion section 312.

The HTML tag conversion section 30 analyzes the HTML data acquired by the Web capture section 204 from the Web server 4, and performs conversion of a tag necessary for the user to perform Web page reading through the e-mail client 6.

The HTML tag extraction section 300 extracts a tag from the HTML data acquired from the Web server 4, and controls a tag conversion processing.

The link tag conversion section 302 performs conversion of a link tag, and converts the URL specified by an “href” attribute into a mailto format conforming to Request For Comment (RFC) 2368. That is, the link tag conversion section 302 executes the following conversion processing.

If the link tag embedded in a general Web page is described as follows,

<a href=“(link target URL)”>(character string representing a link to the “link target URL”)</a>

the link tag conversion section 302 converts the description into the following description.

<a href=“mailto:(e-mail address of the data-reading server 2)?subject=(Web page title)&body=(link target URL)”>(character string representing a link to the “link target URL”)</a>

By this processing, when the user of the e-mail client 6 clicks on the character string representing the link to the URL by using the input/output device 126, the e-mail client 6 automatically composes an e-mail with:

the e-mail address of the data-reading server 2 inserted in a destination field;

the Web page title inserted in a subject field; and

the link target URL inserted in a body field, without the user's operation.

Further, if data indicated by the URL specified by the “href” attribute is data other than HTML data, the link tag conversion section 302 converts an ID (file name) of the specified data into a cid format conforming to RFC 2557.

That is, if the link tag is described as follows,

<a href=“(ID of data indicated by a URL)”>(character string representing a link to the “data indicated by the URL”)</a>

the link tag conversion section 302 converts the description into the following description.

<a href=“cid:(ID of data indicated by a URL)”>

Note that the converted tag containing the character string “cid” means that data indicated by the ID exists in MIME-format data described later and that the data is to be used.

By this processing, when the user of the e-mail client 6 clicks on the character string representing the link to the data indicated by the URL by using the input/output device 126, the e-mail client 6 can reference the ID of the data indicated by the URL from the MIME-format data to display the data thereon.

The image tag conversion section 304 performs conversion of an image tag, and converts the ID (file name) specified by a “src” attribute into a cid format conforming to RFC 2557. That is, in a case of performing display of an image in HTML, if the image tag is described as follows,

<img src=“(ID of image data)”>

the image tag conversion section 304 converts the description into the following description.

<img src=“cid:(ID of image data)”>

By this processing, the e-mail client 6 can reference the ID of the image data from the MIME-format data to display the image data thereon.

The Flash tag conversion section 306 performs conversion of a Flash tag, and converts the ID (file name) specified by a “src” attribute into a cid format conforming to RFC 2557. That is, in a case of performing display of a Flash content in HTML, if the Flash tag is described as follows,

<embed src=“(ID of data related to a Flash content)”>

the Flash tag conversion section 306 converts the description into the following description.

<embed src=“cid:(ID of data related to a Flash content)”>

By this processing, the e-mail client 6 can reference the ID of the data related to the Flash content from the MIME-format data to display the data thereon.

The JavaScript tag conversion section 308 performs conversion of a JavaScript tag, and converts the ID (file name) specified by a “src” attribute into a cid format conforming to RFC 2557. That is, in a case of performing display of a JavaScript content in HTML, if the tag is described as follows,

<script src=“(ID of data related to a JavaScript content)”>

JavaScript tag conversion section 308 converts the description into the following description.

<script src=“cid:(ID of data related to a JavaScript content)”>

By this processing, the e-mail client 6 can reference the ID of the data related to the JavaScript content from the MIME-format data to display the data thereon.

The CSS tag conversion section 310 performs conversion of a CSS tag, and converts the ID (file name) specified by a “href” attribute into a cid format conforming to RFC 2557. That is, in a case of performing specification of a style sheet in HTML, if the CSS tag is described as follows,

<Link href=“(ID of CSS data)”>

the CSS tag conversion section 310 converts the description into the following description.

<Link href=“cid:(ID of CSS data)”>

By this processing, the e-mail client 6 can reference the ID of the CSS data from the MIME-format data to perform the specification of the style sheet by using the data.

The form tag conversion section 312 performs conversion of a form tag, and converts the URL specified by an “action” attribute into the URL in the search server 8. That is, the form tag conversion section 312 executes the following conversion processing.

If the form tag embedded in a general Web page is described as follows,

<form action=“(URL in the Web server 4)”></form>

the form tag conversion section 312 converts the description into the following description.

<form action=“(ID of the search server 8)”></form>

By this processing, the e-mail client 6 can transmit an HTTP request containing the form inputting information to the search server 8.

Further, the form tag conversion section 312 adds information necessary for the search server 8 to compose a mailto-format HTTP response. That is, the form tag conversion section 312 adds the following tags.

<input type=hidden name=url value=“(URL in the Web server 4)”>
<input type=hidden name=mailto value=“(ID of the data-reading server 2)”>
<input type=hidden name=subject value=“(Web page title)”>

By this processing, the search server 8 that has received the HTTP request from the e-mail client 6 can compose the URL indicating the original data, the ID of the data-reading server 2, and the Web page title.

The MIME format conversion section 320 (FIG. 5) converts the HTML data inputted from the HTML tag conversion section 30 and the data of the related file inputted from the related file extraction section 280 into MIME-format data conforming to RFC 1521. The MIME-format data represents data of such a format that the content of the HTML data and the content of the data of the related file constituting the Web page are combined into one.

By adopting this format, not only the HTML data but also data other than the HTML data such as image data can also be transmitted as a single data item by use of the e-mail.

The MIME format conversion section 320 performs a processing for adding information indicating that the HTML data is text data described in HTML and information indicating a character code of the text data to the HTML data as a header. In addition, the MIME format conversion section 320 converts (encodes) the data (such as image data) of the related file constituting the Web page into text data in a format (for example, BASE64) that can be decoded by the e-mail client 6. Further, the MIME format conversion section 320 performs a processing for adding information indicating the type of original data, information indicating the above-mentioned encoding format, and the ID of the original data to the encoded data as a header.

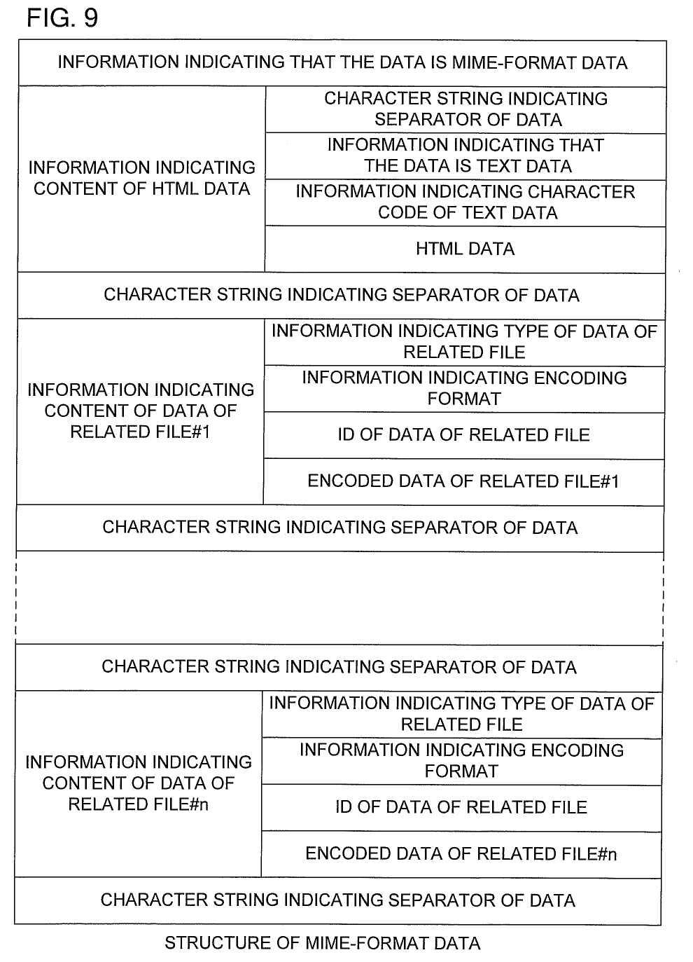

FIG. 9 is a diagram showing an example of a structure of the MIME-format data according to the present invention. As shown in FIG. 9, the MIME-format data according to the present invention has such a structure as to contain information indicating that the data is the MIME-format data, information indicating the content of the HTML data, and information indicating the content of the data of a plurality of related files, with a character string indicating a separator of data being inserted in each of boundaries therebetween. The information indicating the content of the HTML data contains information indicating that the data is text data, information indicating the character code of the text data, and the HTML data.

The information indicating the content of the data of the related file contains information indicating the type of the data of the related file, information indicating the encoding format, the ID of the data of the related file, and the encoded data of the related file. Further, the MIME format conversion section 320 uses the MIME-format data to compose data of the e-mail body for transmission to the e-mail client 6, and outputs the data to the e-mail composition section 340.

The e-mail composition section 340 composes an e-mail transmitted to the e-mail client 6 by using a sender address inputted from the sender address extraction section 232 and the data of the e-mail body inputted from the MIME format conversion section 320. Further, the e-mail composition section 340 outputs the composed e-mail to the e-mail transmitting section 224.

Note that if the data indicated by the URL is not data described in HTML format, the Web capture section 204 downloads the data indicated by the URL from the Web server 4.

The e-mail composition section 340 composes an e-mail with the downloaded data added as an attached file. This allows the user of the e-mail client 6 to even download the data linked to the Web page by using an e-mail from the e-mail client 6.

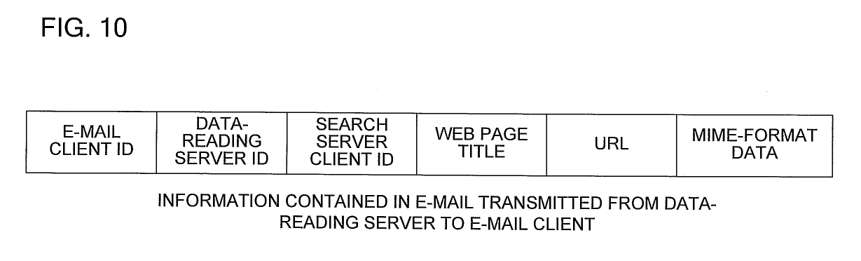

FIG. 10 is a diagram showing information contained in the e-mail transmitted from the data-reading server 2 shown in FIG. 1 to the e-mail client 6. As shown in FIG. 10, the e-mail transmitted from the data-reading server 2 to the e-mail client 6 contains the e-mail client ID, the data-reading server ID, a search server client ID, the Web page title, the URL, and the MIME-format data.

The e-mail transmitting section 224 (FIG. 5) outputs to the communication processing section 200 the information of the e-mail shown in FIG. 10 received from the e-mail composition section 340.

FIG. 11 is a diagram showing a configuration of the user management section 36 shown in FIG. 5. As shown in FIG. 11, the user management section 36 is configured by including a user information management section 360, a user information DB 362, a user access history information management section 364, a user access history information DB 366, a bookmark information management section 368, a bookmark information DB 370, a session information management section 372, and a session information DB 374. By those components, the user management section 36 performs management of user information, user access history information, bookmark information, and session information.

The user information management section 360 stores the user information (for example, an e-mail address of the user permitted to read the Web data) for performing user authentication in the user information DB 362, and thus manages the user information.

The user authentication section 350 (FIG. 5) performs a processing necessary for the authentication of the sender by using the user information stored in the user information DB 362 and the sender address information inputted from the sender address extraction section 232. By this processing, the data-reading server 2 returns an e-mail containing the Web data only to the authenticated user.

The user access history information management section 364 stores information related to a user's access history to a Web page in the user access history information DB 366, and thus manages the information related to a user's access history.

The bookmark information management section 368 stores information related to a bookmark in the bookmark information DB 370, and thus manages the information related to a bookmark.

The Web capture section 204 performs a processing for setting a communication session between the Web server 4 and the data-reading server 2, and outputs the session information such as an obtained cookie to the session information management section 372 of the user management section 36.

Meanwhile, the user authentication section 350 outputs the sender address information to the session information management section 372. The session information management section 372 stores the session information such as a cookie inputted from the Web capture section 204 and the sender address information inputted from the user authentication section 350 in association with each other in the session information DB 374, and performs a processing for maintaining the session. By this processing, upon requesting for the Web data corresponding to the e-mail from a certain user, the data-reading server 2 adds the session information corresponding to the user's e-mail address to the request with respect to the Web server 4. Once the Web server 4 recognizes the session information, it becomes possible to maintain the session.

Web Server Program 40

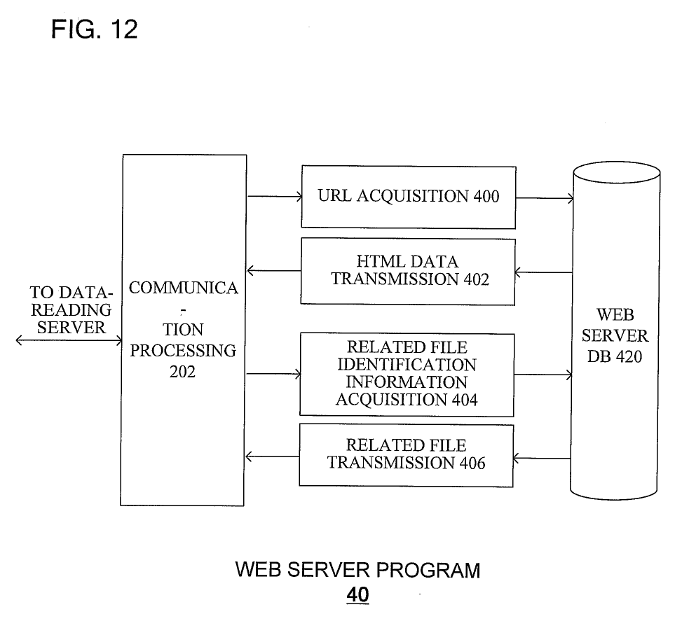

FIG. 12 is a diagram showing a Web server program 40 running on the Web server 4 shown in FIG. 1. As shown in FIG. 12, the Web server program 40 is configured by including the communication processing section 202, a URL acquisition section 400, an HTML data transmission section 402, a related file identification information acquisition section 404, a related file transmission section 406, and a Web server DB 420. By those components, the Web server program 40 distributes HTML data of a resource indicated by the URL inputted from the data-reading server 2 to the data-reading server 2 via the internal network 160. In addition, the Web server program 40 distributes the related file requested by the data-reading server 2 to the data-reading server 2 via the internal network 160.

In the Web server program 40, the URL acquisition section 400 acquires the URL transmitted from the data-reading server 2, outputs the acquired URL to the Web server DB 420, and performs a request for the HTML data.

The HTML data transmission section 402 acquires from the Web server DB 420 the HTML data with reference to the resource indicated by the URL inputted by the URL acquisition section 400. Further, the HTML data transmission section 402 outputs the acquired data to the data-reading server 2 via the communication processing section 202 and the internal network 160.

The related file identification information acquisition section 404 acquires identification information of the related file constituting the Web page inputted from the data-reading server 2. Further, the related file identification information acquisition section 404 outputs the acquired identification information to the Web server DB 420, and performs a request for the related file.

The related file transmission section 406 acquires the related file constituting the Web page from the Web server DB 420 based on the identification information of the related file. Further, the related file transmission section 406 outputs the acquired file to the data-reading server 2 via the communication processing section 202 and the internal network 160.

E-mail client program 60

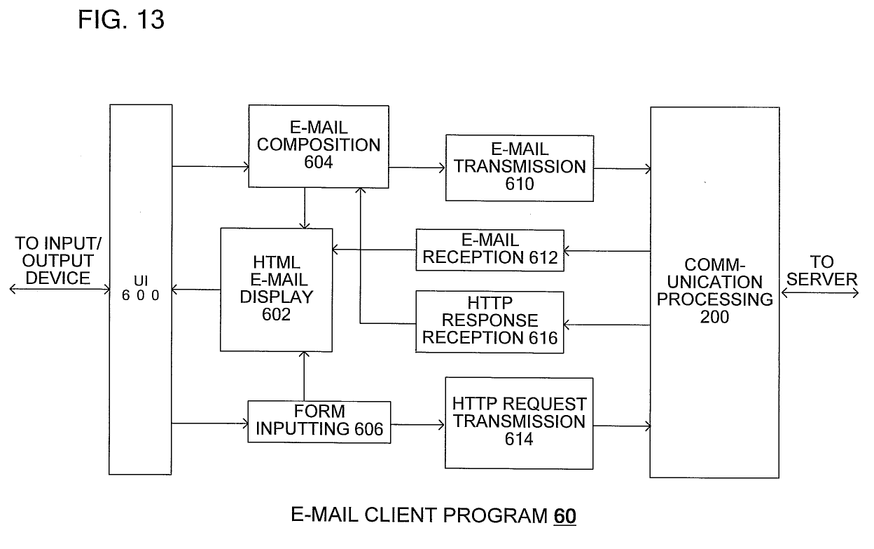

FIG. 13 is a diagram showing an e-mail client program 60 running on the e-mail client 6 shown in FIG. 1. As shown in FIG. 13, the e-mail client program 60 is configured by including the communication processing section 200, a user interface (UI) section 600, an HTML e-mail display section 602, an e-mail composition section 604, a form inputting section 606, an e-mail transmission section 610, an e-mail reception section 612, an HTTP request transmission section 614, and an HTTP response reception section 616. By those components, the e-mail client program 60 transmits the e-mail containing the URL of the user's desired Web page to the data-reading server 2.

Further, the e-mail client program 60 receives the e-mail containing the Web data with reference to the resource containing the above-mentioned URL from the data-reading server 2, and displays the Web page based on the above-mentioned Web data. In addition, the e-mail client program 60 automatically composes an e-mail containing the link target URL in response to the user's clicking operation with respect to a link within the Web page displayed on the e-mail client 6.

The e-mail client program 60 transmits an HTTP request containing the form inputting information to the search server 8. Further, the e-mail client program 60 receives a mailto-format HTTP response containing the URL corresponding to the form inputting information from the search server 8. In addition, the e-mail client program 60 automatically composes an e-mail containing the URL corresponding to the form inputting information according to the reception of the mailto-format HTTP response.

In the e-mail client program 60, the UI section 600 receives the user's operation with respect to the input/output device 126, and outputs data indicating the received operation to the e-mail composition section 604 and the form inputting section 606. In addition, the UI section 600 controls processings of the other components of the e-mail client program 60 according to the user's operation. Further, the UI section 600 displays HTML-format data processed by the HTML e-mail display section 602 on the input/output device 126.

The e-mail composition section 604 composes an e-mail by an input of the data indicating the user's operation from the UI section 600, and outputs the composed e-mail information to the HTML e-mail display section 602 and the e-mail transmission section 610. In addition, when data indicating that a link within the Web page is clicked is inputted from the UI section 600, the e-mail composition section 604 composes an e-mail automatically without the user's operation, the e-mail having the link target URL as the body and the ID (e-mail address) of the data-reading server 2 as the destination.

The form inputting section 606 composes form inputting information by an input of the data indicating the user's operation from the UI section 600, and outputs the composed form inputting information to the HTML e-mail display section 602 and the HTTP request transmission section 614. The HTML e-mail display section 602 processes the e-mail information inputted from the e-mail composition section 604 so as to be displayed in an HTML format, and outputs the processed data to the UI section 600. In addition, the HTML e-mail display section 602 processes the form inputting information inputted from the form inputting section 606 so as to be displayed in an HTML format, and outputs the processed data to the UI section 600.

The e-mail transmission section 610 transmits the e-mail containing the information shown in FIG. 6 composed based on the user's operation to the data-reading server 2 indicated by the data-reading server ID.

The e-mail reception section 612 outputs the e-mail containing the information shown in FIG. 10 received from the data-reading server 2 to the HTML e-mail display section 602.

The HTML e-mail display section 602 subjects the e-mail information inputted from the e-mail reception section 612 to a processing such as decoding that allows the display in an HTML format, and outputs the processed data to the UI section 600.

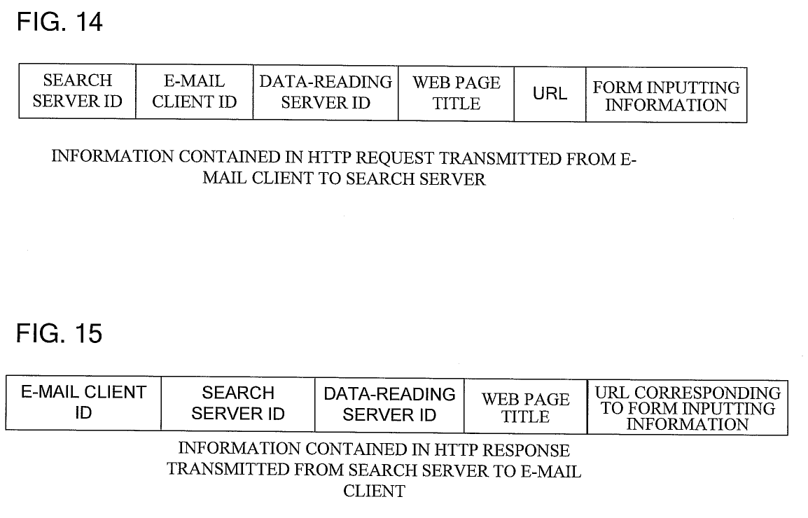

FIG. 14 is a diagram showing information contained in the HTTP request transmitted from the e-mail client 6 shown in FIG. 1 to the search server 8. As shown in FIG. 14, the HTTP request transmitted from the e-mail client 6 to the search server 8 contains the search server ID, the e-mail client ID, the data-reading server ID, the Web page title, the URL, and the form inputting information. The HTTP request transmission section 614 (FIG. 13) transmits the HTTP request containing the information shown in FIG. 14 received from the form inputting section 606 to the search server 8 indicated by the search server ID.

FIG. 15 is a diagram showing information contained in the mailto-format HTTP response transmitted from the search server 8 shown in FIG. 1 to the e-mail client 6. As shown in FIG. 15, the HTTP response transmitted from the search server 8 to the e-mail client 6 contains the e-mail client ID, the search server ID, the data-reading server ID, the Web page title, and the URL corresponding to the form inputting information.

The HTTP response reception section 616 (FIG. 13) outputs to the e-mail composition section 604 the mailto-format HTTP response containing the information shown in FIG. 15 received from the search server 8.

When the mailto-format HTTP response is inputted, the e-mail composition section 604 composes an e-mail automatically without the user's operation, the e-mail having the URL corresponding to the form inputting information as the body and the ID (e-mail address) of the data-reading server 2 as the destination.

Search Server Program 80

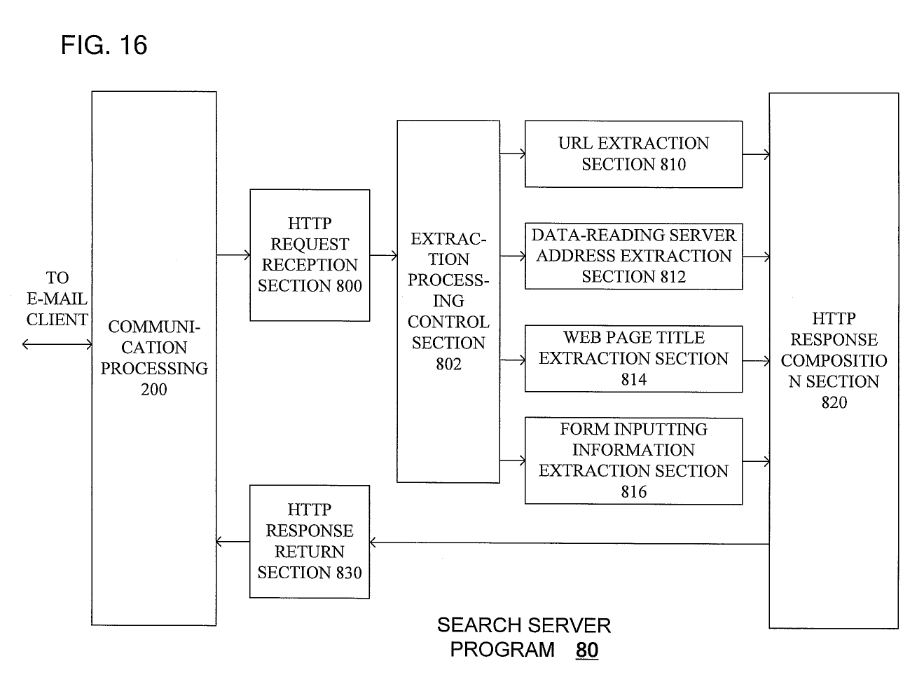

FIG. 16 is a diagram showing a search server program 80 running on the search server 8 shown in FIG. 1. As shown in FIG. 16, the search server program 80 is configured by including an HTTP request reception section 800, an extraction processing control section 802, a URL extraction section 810, a data-reading server address extraction section 812, a Web page title extraction section 814, a form inputting information extraction section 816, an HTTP response composition section 820, and an HTTP response return section 830. By those components, the search server program 80 extracts the URL, the address of the data-reading server 2, and the Web page title from the HTTP request containing the form inputting information received from the e-mail client 6.

Further, the search server program 80 transmits to the e-mail client 6 such a mailto-format HTTP response as to have the URL, to which a parameter corresponding to the form inputting information is added, as the body.

In the search server program 80, the HTTP request reception section 800 receives the HTTP request containing the information shown in FIG. 14 from the e-mail client 6. Further, the HTTP request reception section 800 outputs the received HTTP request to the extraction processing control section 802. The extraction processing control section 802 sets the parameter, which is contained in the information inputted from the HTTP request reception section 800, in each of the URL extraction section 810, the data-reading server address extraction section 812, the Web page title extraction section 814, and the form inputting information extraction section 816, and causes each of the components to execute an extraction processing.

The URL extraction section 810 extracts the URL from the information contained in the HTTP request, and outputs the extracted URL to the HTTP response composition section 820.

The data-reading server address extraction section 812 extracts the address of the data-reading server 2 from the information contained in the HTTP request, and outputs the extracted address to the HTTP response composition section 820.

The Web page title extraction section 814 extracts the Web page title from the information contained in the HTTP request, and outputs the extracted title to the HTTP response composition section 820.

The form inputting information extraction section 816 extracts the form inputting information from the information contained in the HTTP request, and outputs the extracted form inputting information to the HTTP response composition section 820.

The HTTP response composition section 820 composes a header part of the mailto-format HTTP response based on the information inputted from the URL extraction section 810, the data-reading server address extraction section 812, and the title extraction section 814.

In addition, the HTTP response composition section 820 composes a URL to be the body of the HTTP response to which a parameter corresponding to the form inputting information inputted from the form inputting information extraction section 816 is added.

Further, the HTTP response composition section 820 combines the composed header and body to compose a mailto-format HTTP response. The HTTP response composition section 820 outputs the composed mailto-format HTTP response to the HTTP response return section 830. The HTTP response return section 830 returns to the e-mail client 6 the mailto-format HTTP response containing the information shown in FIG. 15, which has been inputted from the HTTP response composition section 820.

Overall Operation of the Web Page-Reading System 1

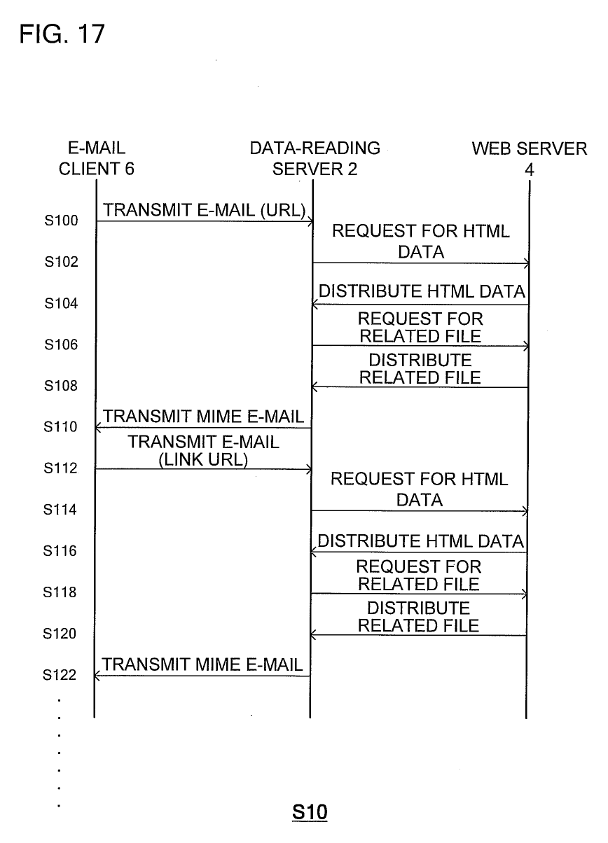

Hereinafter, description will be made of an overall operation of the Web page-reading system 1. FIG. 17 is a communication sequence diagram showing an overall operation (S10) of the Web page-reading system 1 shown in FIG. 1 in a case where the form inputting is not taken into consideration. As shown in FIG. 17, in Step 100 (S100), the e-mail client 6 transmits to the data-reading server 2 the e-mail containing the user's desired URL, which has been composed by the user's operation with respect to the input/output device 126.

In Step 102 (S102), the data-reading server 2 requests the Web server 4 to distribute the HTML data indicated by the URL.

In Step 104 (S104), the Web server 4 distributes the HTML data indicated by the URL to the data-reading server 2.

In Step 106 (S106), the data-reading server 2 requests the Web server 4 to distribute the related file constituting the Web page.

In Step 108 (S108), the Web server 4 distributes the related file constituting the Web page to the data-reading server 2.

In Step 110 (S110), the data-reading server 2 transmits the e-mail converted into a MIME format to the e-mail client 6 based on the HTML data and related file that have been distributed from the Web server 4.

In Step 112 (S112), the e-mail client 6 transmits to the data-reading server 2 the e-mail containing the link target URL composed automatically by clicking on the link within the Web page.

In Step 114 (S114), the data-reading server 2 requests the Web server 4 to distribute the HTML data indicated by the link target URL.

In Step 116 (S116), the Web server 4 distributes the HTML data indicated by the link target URL to the data-reading server 2.

In Step 118 (S118), the data-reading server 2 requests the Web server 4 to distribute the related file constituting the link target Web page.

In Step 120 (S120), the Web server 4 distributes the related file constituting the link target Web page to the data-reading server 2.

In Step 122 (S122), the data-reading server 2 transmits the e-mail converted into a MIME format to the e-mail client 6 based on the HTML data and related file that have been distributed from the Web server 4.

Note that the steps S102, S104, S106, S108, S114, S116, S118, and S120 can be performed repeatedly as necessary until all of the necessary data have been distributed to the data-reading server 2.

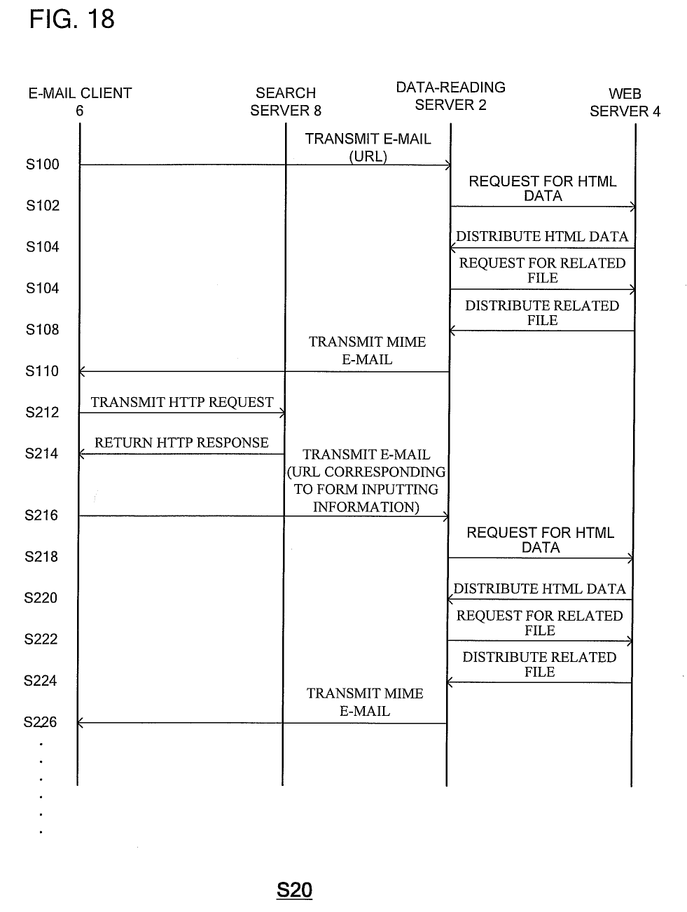

FIG. 18 is a communication sequence diagram showing an overall operation (S20) of the Web page-reading system 1 shown in FIG. 1 in a case where the form inputting is taken into consideration.

As shown in FIG. 18, in Step 212 (S212), the e-mail client 6 transmits to the search server 8 the HTTP request containing the form inputting information, which has been composed by the user operating the input/output device 126.

In Step 214 (S214), the search server 8 returns to the e-mail client 6 the mailto-format HTTP response containing an “HTTP GET”-format URL composed in correspondence with the form inputting information.

In Step 216 (S216), the e-mail client 6 transmits to the data-reading server 2 the e-mail containing the URL corresponding to the form inputting information, which has been composed automatically in response to the reception of the mailto-format HTTP response.

In Step 218 (S218), the data-reading server 2 requests the Web server 4 to distribute the HTML-format data indicated by the URL corresponding to the form inputting information.

In Step 220 (S220), the Web server 4 distributes the HTML data indicated by the URL to the data-reading server 2.

In Step 222 (S222), the data-reading server 2 requests the Web server 4 to distribute the related file constituting the Web page.

In Step 224 (S224), the Web server 4 distributes the related file constituting the Web page to the data-reading server 2.

In Step 226 (S226), the data-reading server 2 transmits the e-mail converted into a MIME format to the e-mail client 6 based on the HTML data and related file that have been distributed from the Web server 4.

Note that the steps S102, S104, S106, S1 08, S218, S220, S222, and S224 can be performed repeatedly as necessary until all of the necessary data have been distributed to the data-reading server 2.

### INDUSTRIAL APPLICABILITY

The present invention can be used for the data reading.

### DESCRIPTION OF REFERENCE NUMERALS

1 . . . Web page-reading system
100 . . . network
16 . . . intranet
160 . . . internal network
180 . . . e-mail gateway
2 . . . data-reading server
120 . . . main body
122 . . . CPU
124 . . . memory
126 . . . input/output device
128 . . . network device
130 . . . recording device
132 . . . recording medium
20 . . . data-reading server program
200, 202 . . . communication processing section
204 . . . Web capture section
210 . . . Web page DB
222 . . . e-mail reception section
224 . . . e-mail transmission section
226 . . . e-mail analysis section
230 . . . URL extraction section
232 . . . sender address extraction section
24 . . . portal processing section
240 . . . keyword extraction section
242 . . . bookmark processing section
244 . . . history processing section
246 . . . account processing section
248 . . . automatic distribution processing section
250 . . . browser setting processing section
260 . . . URL access section
280 . . . related file extraction section
30 . . . HTML tag conversion section
300 . . . HTML tag extraction section
302 . . . link tag conversion section
304 . . . image tag conversion section
306 . . . Flash tag conversion section
308 . . . JavaScript tag conversion section
310 . . . CSS tag conversion section
312 . . . form tag conversion section
320 . . . MIME format conversion section
340 . . . e-mail composition section
350 . . . user authentication section
36 . . . user management section
360 . . . user information management section
362 . . . user information DB
364 . . . user access history information management section
366 . . . user access history information DB
368 . . . bookmark information management section
370 . . . bookmark information DB
372 . . . session information management section
374 . . . session information DB
4 . . . Web server
40 . . . Web server program
400 . . . URL acquisition section
402 . . . HTML data transmission section
404 . . . related file identification information acquisition section
406 . . . related file transmission section
420 . . . Web server DB
6 . . . e-mail client
60 . . . e-mail client program
600 . . . UI section
602 . . . HTML e-mail display section
604 . . . e-mail composition section
606 . . . form inputting section
610 . . . e-mail transmission section
612 . . . e-mail reception section
614 . . . HTTP request transmission section
616 . . . HTTP response reception section
8 . . . search server
80 . . . search server program
800 . . . HTTP request reception section
802 . . . extraction processing control section
810 . . . URL extraction section
812 . . . data-reading server address extraction section
814 . . . Web page title extraction section
816 . . . form inputting information extraction section
820 . . . HTTP response composition section
830 . . . HTTP response return section

1. A data transmission system, comprising:
a first network; and
a second network,
the first network having Web data, which is contained in a Web page, transmitted only inside the first network, the first network and the second network having data transmitted therebetween by e-mail, an e-mail that contains specification data for specifying the Web data being transmitted from the second network to the first network, wherein:
the first network includes:
a data storage device for storing the Web data; and
a data-reading device for reading, from among the stored Web data, Web data indicated by the specification data contained in the e-mail received from the second network, and returning an e-mail containing the read Web data to the second network;
the second network is connected with an e-mail device for transmitting the e-mail containing the specification data to the first network, and receiving the e-mail returned from the first network;
the e-mail device includes:
reception means for receiving the e-mail from the first network via the second network;
e-mail display means for displaying a content of the e-mail, which displays a content of the received Web data; and
transmission means for transmitting the e-mail containing the specification data to the first network via the second network; and
the data-reading device includes:
conversion means for converting the read Web data in a manner adapted for display by the e-mail display means of the e-mail device; and
transmission means for transmitting an e-mail containing the converted Web data to the e-mail device via the second network.

2. A data transmission system according to claim 1, wherein:
the Web data includes an HTML tag; and
the conversion means of the data-reading device further converts the HTML tag into data indicating a display processing conforming to a display format employed in the e-mail display means for the e-mail device.

3. (canceled)

4. A data transmission system according to claim 1, wherein:
the specification data for specifying the predetermined data comprises a URL;
the first network comprises an intranet; and
the second network comprises an internet.

5. A data transmission system according to claim 1, wherein:
the Web data further includes specification data for specifying another Web data;
the e-mail device further includes selection means for selecting the specification data contained in the received Web data; and
the transmission means transmits an e-mail containing the selected specification data.

6. A data transmission system according to claim 5, wherein:
the Web data further includes an operation target image for receiving an operation from an outside;
the e-mail display means of the e-mail device further displays the operation target image contained in the Web data;
the e-mail device further includes operation reception means for receiving an operation performed with respect to the displayed operation target image; and
the selection means of the e-mail device selects one or more items from the specification data of the another Web data contained in the Web data of the received e-mail according to the operation with respect to the displayed operation target image.

7. A data transmission system according to claim 5, wherein the specification data contained in the Web data comprises the Web data for specifying the another Web data corresponding to the Web data.

8. A data transmission system according to claim 1, wherein:
the second network further includes a search device for searching, in response to a request containing operation information transmitted from the e-mail device, for the specification data of the Web data corresponding to the operation information contained in the request, and returning the specification data obtained as a search result to the e-mail device that has transmitted the request;
the e-mail device further includes e-mail composition means for composing an e-mail that contains the specification data returned from the search device; and
the transmission means further transmits the composed e-mail to the first network via the second network.

9. A data transmission system according to claim 8, wherein:
the conversion means of the data-reading device further converts the read Web data into data containing identification information of the search device; and
the transmission means of the e-mail device further transmits the request containing the operation information to the search device indicated by the identification information.

10. A data transmission system according to claim 1, wherein the data-reading device further includes:
extraction means for extracting identification information from the received e-mail; and
authentication means for authenticating a sender of the e-mail based on the extracted identification information.

11. A data transmission system according to claim 10, wherein the data-reading device further includes:
identification information storage means for storing the extracted identification information; and
access means for accessing the data storage device based on the stored identification information.

12. A data transmission system according to claim 1, wherein:
the data-reading device further includes data-use function providing means for providing a function for using the Web data;
an e-mail containing data-use function specification information for specifying a content of the data-use function is transmitted from the second network to the first network; and
the data-use function providing means provides the data-use function according to the data-use function specification information.

13. A data transmission method for a data transmission system including a first network and a second network, the first network having Web data, which is contained in a Web page, transmitted only inside the first network, the first network and the second network having data transmitted therebetween by e-mail, an e-mail that contains specification data for specifying the Web data being transmitted from the second network to the first network,
the data transmission method comprising:
a storage step of storing, in the first network, the Web data;
a data-reading step of reading, in the first network, from among the stored Web data, Web data indicated by the specification data contained in the e-mail received from the second network, and returning an e-mail containing the read Web data to the second network,
the second network being connected with an e-mail device for transmitting the e-mail containing the specification data to the first network, and receiving the e-mail returned from the first network,
a reception step of receiving, by the e-mail device, the e-mail from the first network via the second network;
an e-mail display step of displaying, by the e-mail device, a content of the e-mail, which displays a content of the received Web data; and
a transmission step of transmitting, by the e-mail device, the e-mail containing the specification data to the first network via the second network,
wherein the data-reading step includes:
a conversion step of converting the read Web data in a manner adapted for display in the e-mail display step of the e-mail device; and
a transmission step of transmitting an e-mail containing the converted Web data to the e-mail device via the second network.

14. A data transmission program for a data transmission system including a first network that includes respective computers and a second network, the first network having Web data, which is contained in a Web page, transmitted only inside the first network, the first network and the second network having data transmitted therebetween by e-mail, an e-mail that contains specification data for specifying the Web data being transmitted from the second network to the first network,
the data transmission program causing the computers of the first network to execute:
a storage step of storing the Web data; and
a data-reading step of reading, from among the stored Web data, Web data indicated by the specification data contained in the e-mail received from the second network, and returning an e-mail containing the read Web data to the second network
the second network being connected with an e-mail device for transmitting the e-mail containing the specification data to the first network, and receiving the e-mail returned from the first network,
the data transmission program further causing the e-mail device to execute:
a reception step of receiving the e-mail from the first network via the second network;
an e-mail display step of displaying a content of the e-mail, which displays a content of the received Web data; and
a transmission step of transmitting the e-mail containing the specification data to the first network via the second network,
wherein the data-reading step includes:
a conversion step of converting the read Web data in a manner adapted for display in the e-mail display step of the e-mail device; and
a transmission step of transmitting an e-mail containing the converted Web data to the e-mail device via the second network.
